(19) United States
(12) Patent Application Publication
(10) Pub. No.: US 2017/0298686 A1
(43) Pub. Date: Oct. 19, 2017

(54) Magnetic Blinds

(71) Applicant: Nathan Cheng, Los Alamitos, CA (US)

(72) Inventor: Nathan Cheng, Los Alamitos, CA (US)

(21) Appl. No.: 15/131,296

(22) Filed: Apr. 18, 2016

(51) Int. Cl. E06B 9/32; E06B 9/386; E06B 9/384

(52) U.S. Cl. CPC E06B 9/32; E06B 9/384; E06B 9/386

(57) ABSTRACT

A magnetic blind device includes boards. The boards are stacked in a vertically oriented arrangement. The boards have openings through the boards. A top board is higher than a bottom board. An elevation line passes through the openings of the boards from the top board to the bottom board. The elevation line is for raising the blinds. Magnetic strips can be mounted to a left side and a right side of each board of the boards. A metal strip can be positioned to contact the plurality of magnetic strips when the plurality of magnetic strips transfers from a dormant position to an activated position. The magnetic strips attract to each other and to the metal strip. Optionally, an electromagnet can selectively magnetize the metal strip when an electromagnet switch is activated. The magnet strip is preferably rectangular.

This application is a non-provisional application claiming priority of provisional application 62/149,661, filed Apr. 19, 2015, entitled Magnetic Blinds, the disclosure which is incorporated herein by reference.

### FIELD OF THE INVENTION

The present invention is in the field of window coverings, namely blinds.

### DISCUSSION OF RELATED ART

A wide variety of different blinds have been used for covering windows and controlling light into a window. Traditionally, blinds have been used in ancient societies such as Roman times. A variety of different window covering control devices have been used for improved light control.

### SUMMARY OF THE INVENTION

The object of the invention is to provide a dark room. This provides good sleep. When the bright moon is out, sleepers don't want to be disturbed, so the pitch darkness would help. My invention would seal a light so invaders can only invade with uncertainty if there are people inside. This invention was created so there would be a complete seal, which other inventions only have a partial seal.

A magnetic blind device includes boards. The boards are stacked in a vertically oriented arrangement. The boards have openings through the boards. A top board is higher than a bottom board. An elevation line passes through the openings of the boards from the top board to the bottom board. The elevation line is for raising the blinds. Magnetic strips can be mounted to a left side and a right side of each board of the boards. A metal strip can be positioned to contact the plurality of magnetic strips when the plurality of magnetic strips transfers from a dormant position to an activated position. The magnetic strips attract to each other and to the metal strip. Optionally, an electromagnet can selectively magnetize the metal strip when an electromagnet switch is activated. The magnet strip is preferably rectangular.

### BRIEF DESCRIPTION OF THE DRAWINGS

FIG. 1 is a front view.

FIG. 2 is a unsealed side view.

FIG. 3 is a sealed side view

FIG. 4 is a unsealed electromagnetic option.

FIG. 5 is a top or bottom view of a board.

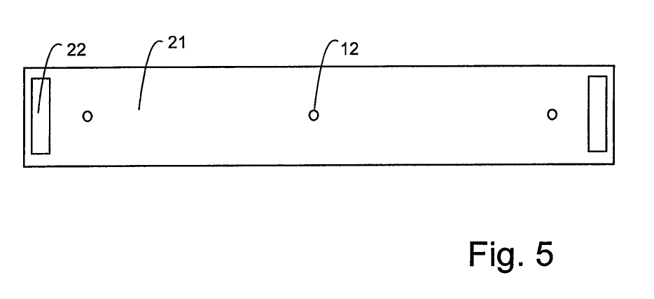

The following call out list of elements can be a useful guide in referencing the element numbers of the drawings.
10 Magnetic Blind Device
11 Elevation Line
12 Elevation Line Opening
13 Control Line
14 Stopper
15 Elcctromagnet
20 Side View of Blind
21 Board
22 Magnet Strip
23 Metal Strip
24 Additional Blind Space
31 First Angle Control Cord (Right)
32 Second Angle Control Cord (Left)
33 Height Control Cord
41 Positive Battery Terminal Wire
42 Negative Battery Terminal Wire
43 Negative Battery Terminal
44 Positive Battery Terminal
45 Battery
46 Node
47 Positive Battery Switch

### DESCRIPTION

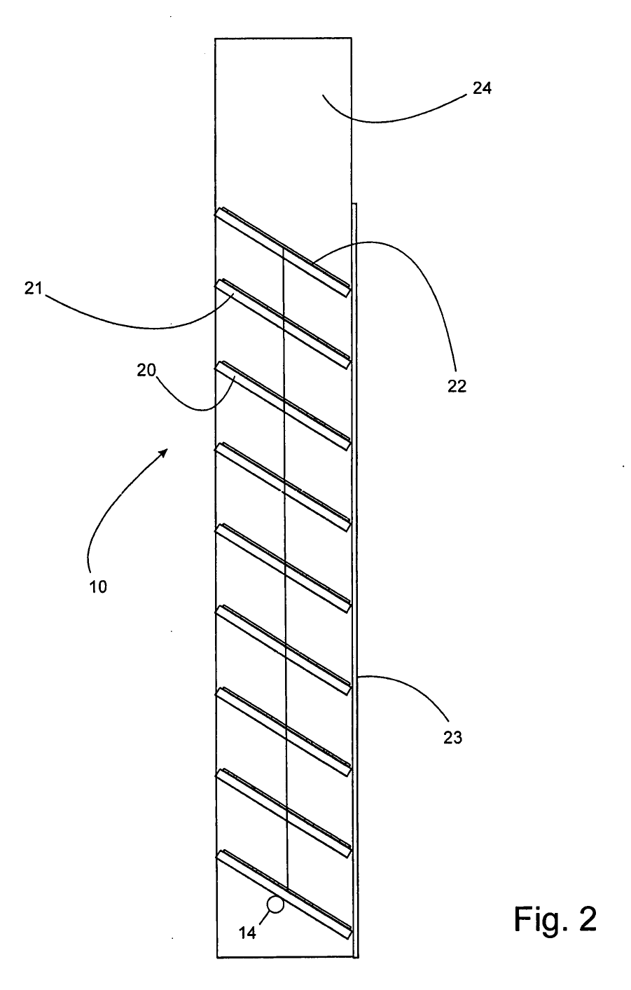

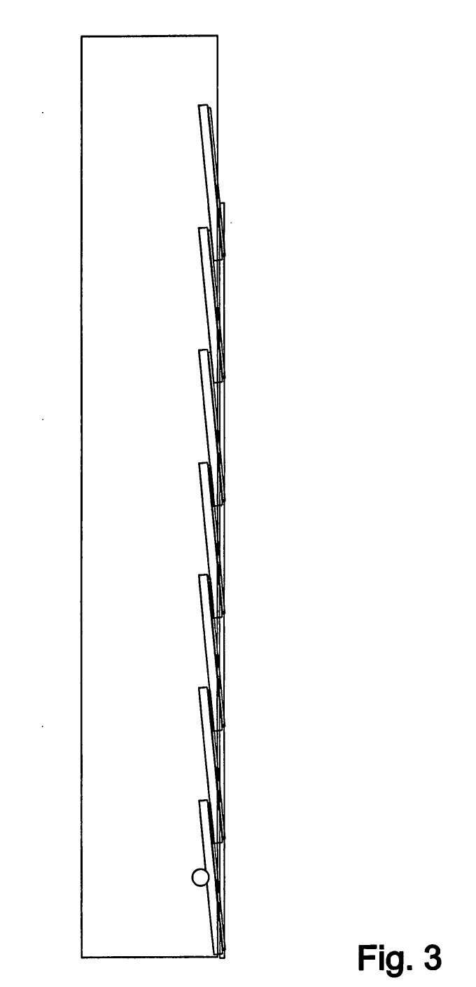

There are many purposes and functions of this magnetic blind device 10. The control line 13 and elevation line 11 control the position of the boards. In order to pass through the boards 21, the elevation line must pass through an opening 12 through the boards. This pulls up the blinds. Because the elevation line 11 is connected to the bottom board. As the bottom board is lifted by the elevation line 11, the bottom board raises the boards above the bottom board as the bottom board travels up. The bottom board stacks with the boards above the bottom board as the bottom board travels up. When the bottom board travels down, the stack of boards expands so that each board is equal distantly spaced from the one above or below it. The boards in the expanded position have sufficient clearance between them so that they can provide a controlled shading. The elevation line has a metal stopper 14 which can be a rod with a circular or square cross section as shown in FIGS. 2 and 3. When a user pulls the height control cord 33, the blinds are pulled up because the height control cord is connected to the elevation line 11.

When one pulls on the first angle control cord (Right) 31, the boards tilt upwards. Similarly, when one pulls on the second angle control cord (Left) 32, the boards tilt downwards. The first angle control cord 31 can be connected to the second angle control cord 32 such that when the first angle control cord 31 is pulled, the second angle control cord 32 retracts, and likewise such that when the second angle control cord 32 is pulled, the first angle control cord 31 retracts. The pair of angle control cords controls the control line 13. The control line 13 includes a front control line and a rear control line. When the angle control cords angle the boards, the front control line in the rear control line move accordingly.

When a user wants the blinds to stick to the window frame to limit light from the window, the user can create a light proof seal or an almost light proof seal. A magnet strip 22 can be mounted to a topside or a bottom side of each of the boards 21. The magnet strip 22 is preferably mounted at a left side or a right side of each of the boards 21. A magnet strip 22 can attract to the metal strip 23 to form a contact that creates a light proof seal. Each magnet strip 22 also attracts to the other magnet strips 22 to form a chain of individual magnetically attracted magnet strips 22. The metal strip 23 can be attached to the window frame such as a sash. The window frame can be a part of a door, or can be installed to a door. The window frame can be installed to a wall of a structure.

Each of the boards 21, are rectangular and are separate from the general structure 10. Each of the magnet strips 22 adheres to a board 21 such as by glue or rivets. The magnet strips 22 can be adhered to the board 21 using self adhesive tape. The magnet strip 22 can be rectangular. When in use, the blinds close when the board 21 sticks to the metal strip 23. Additional blind space 24 is above the top blind, which is the first blind. The additional blind space 24 is used when the top blind folds up. When not in use, the boards lie in the dormant position as shown in FIG. 2.

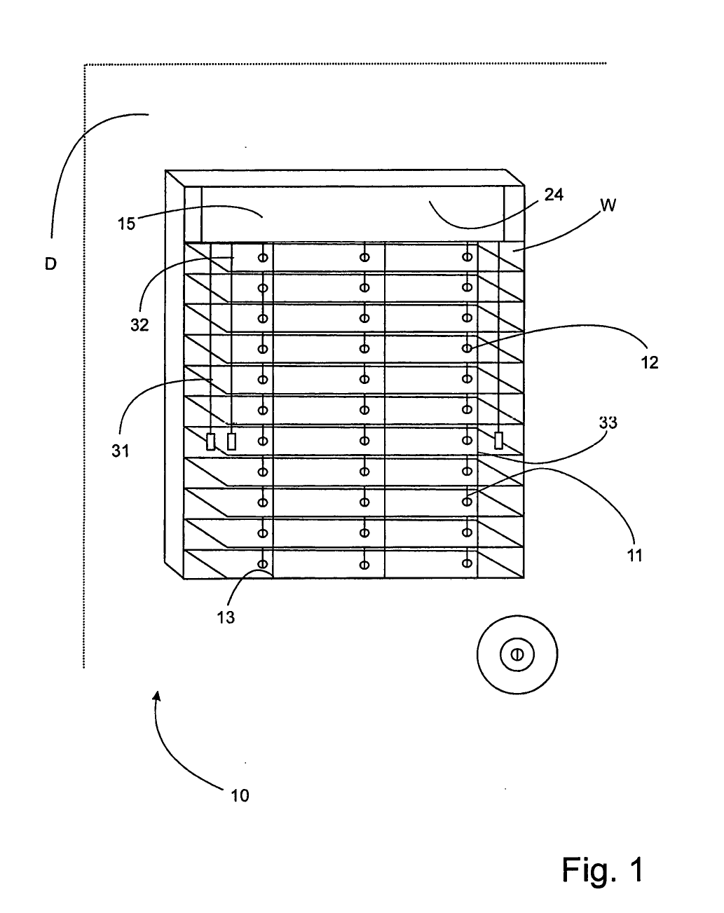

This device can be installed outside a window in the interior of a house. The door is optional as shown in FIG. 1.

The blinds can transfer from the dormant position to the active position when the blinds are manually pressed against the metal strips. Alternatively, the angle adjustment cords can be used for aligning the blinds against the metal strips to activate magnetic adhesion. Optionally, an electromagnet can be used for selectively magnetizing the metal strips to increase magnetic force in the magnetic attraction.

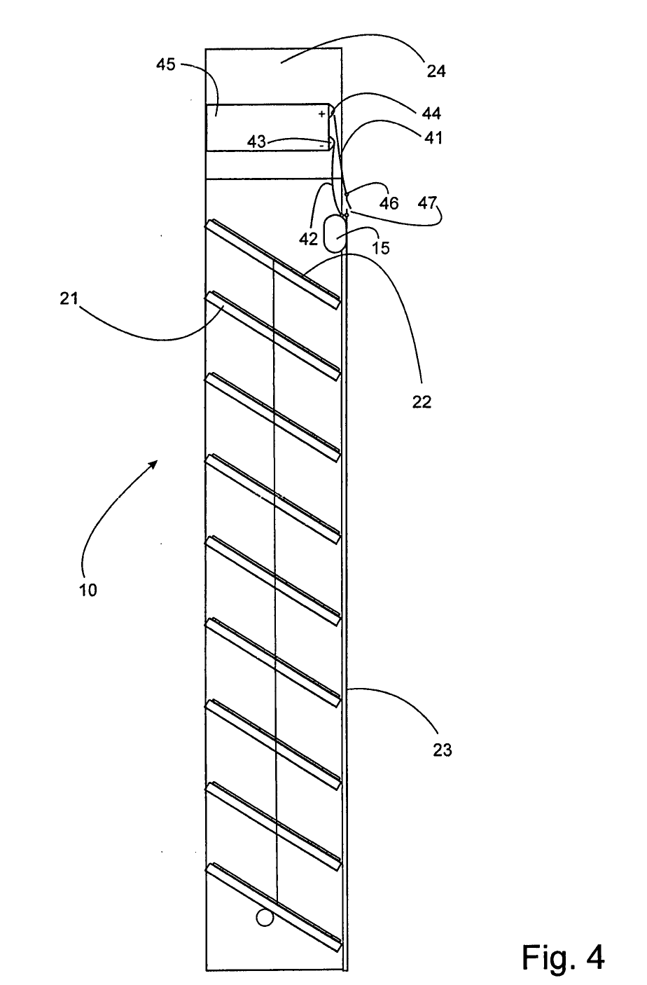

As shown in FIG. 4, there is an optional magnetic switch control system if one desires it. The positive battery terminal wire 41 carries the electrical current down to a node 46, which connects to the electrical switch 47. If the switch 47 is connected to the metal strip 23, the magnetic strip 22 will snap onto the metal strip 23. The magnetic control system has an electromagnet 15 connected to the electrical circuit. The additional blind space 24 can store a portion or all of the electromagnet 15. The electromagnet 15 is attached to the metal strip 23. The electromagnet magnetize the metal strip 23 such that when the metal strip 23 is magnetized, it can attract the magnetic strip 22 of the blinds. Optionally, the magnetic strip 22 of the blinds can be omitted in the electromagnetic configuration by substituting the magnetic strip 22 with steel blinds that attract to magnetic fields. With steel blinds, the electromagnet 15 attracts to the metal blinds directly. It is preferred that aluminum blinds can be augmented with magnetic strips. Additionally, the magnetic strips can be adhered to wooden plank blinds.

A pair of electromagnetic apparatus 15 can be used for the magnetic control system, including a left electromagnetic apparatus and a right electromagnetic apparatus. This provides left side and right side control independent of each other by using a left electromagnet and a right electromagnet. The left electromagnet is controlled by the left electromagnet switch in the right electromagnet is controlled by the right electromagnet switch.

1. A magnetic blind device comprising:
a) boards, wherein the boards are stacked in a vertically oriented arrangement, wherein the boards have openings through the boards, wherein a top board is higher than a bottom board, wherein the boards constitute blinds;
b) an elevation line, wherein the elevation line passes through the openings of the boards from the top board to the bottom board, wherein the elevation line is configured to raise the blinds;
c) a plurality of magnetic strips mounted to a left side and a right side of each board of the boards, wherein the plurality of magnetic strips are attached to an external surface of the boards; and
d) a metal strip, wherein the metal strip is positioned to contact the plurality of magnetic strips when the plurality of magnetic strips transfers from a dormant position to an activated position by rotation, whereby the magnetic strips attract to each other and to the metal strip, wherein the magnetic strips mounted on the left side of each board attract to each other, and wherein the magnetic strips mounted on the right side of each board attract to each other, wherein the metal strip is not mounted to the boards.

2. The magnetic blind device of claim 1, further comprising: an electromagnet that selectively magnetizes the metal strip when an electromagnet switch is activated, wherein activation of the electromagnet biases the blinds closed.

3. The magnetic blind device of claim 1, wherein the plurality of magnetic strips are rectangular.
